(19) United States
(12) Patent Application Publication
(10) Pub. No.: US 2025/0350459 A1
(43) Pub. Date: Nov. 13, 2025

(54) PROCESSOR MODULE INITIALIZATION BASED ON AUTHENTICATION KEY GENERATION AT A SECURITY MODULE

(71) Applicant: Hewlett Packard Enterprise Development LP, Spring, TX (US)

(72) Inventors: Chandrasekhar Puthillathe, Bangalore (IN); Padma Lakshmi Anoop Kulkarni, Bangalore (IN)

(21) Appl. No.: 18/795,881

(22) Filed: Aug. 6, 2024

(30) Foreign Application Priority Data
May 13, 2024 (IN) 202441037681

(51) Int. Cl. H04L 9/32; H04L 9/08

(52) U.S. Cl. CPC H04L 9/32; H04L 9/0869

(57) ABSTRACT

In some examples, a first security module includes a connector interface to removably connect to a processor module. The first security module includes a controller that retrieves information stored at the processor module, the information set by a second security module when binding the second security module with the processor module. The controller reads a first authentication key from a memory of the first security module, and computes a second authentication key based on the information retrieved from the processor module. The controller determines whether to allow an initialization of the processor module based on the first authentication key and the second authentication key.

### BACKGROUND

A computing environment can include various resources to perform respective tasks. An example of a computing environment is a data center operated by an enterprise. Users of the enterprise are able to access resources of the data center. Another example of a computing environment is a cloud computing environment with resources accessible over a network by users of the cloud computing environment.

### BRIEF DESCRIPTION OF THE DRAWINGS

Some implementations of the present disclosure are described with respect to the following figures.

FIG. 1 is a block diagram of an arrangement that includes a security module and a processor module, according to some examples.

FIG. 2 is a flow diagram of a factory provisioning process according to some examples.

FIG. 3 is a flow diagram of a secure binding process according to some examples.

FIG. 4 is a flow diagram of a secure initialization process according to some examples.

FIG. 5 is a flow diagram of a secure re-binding process according to some examples.

FIG. 6 is a block diagram of a security module according to some examples.

FIG. 7 is a block diagram of a storage medium storing machine-readable instructions according to some examples.

FIG. 8 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A modular arrangement of resources in a computing environment can include electronic modules that perform respective tasks. In some examples, the electronic modules can include host processor modules (HPMs) and secure control modules (SCMs). A HPM can include a host central processing unit (CPU) and memory, such as the host CPU and memory of a computer server or another type of electronic device. A SCM can include a management controller and a security subsystem. An example of a management controller that performs management tasks is a baseboard management controller (BMC). An example of a security subsystem is a secure element with a security processor to perform security tasks. Note that there may be other examples of electronic modules in a modular arrangement of resources.

By using HPMs and SCMs, host processing functionalities (in a HPM) and management and security functionalities (in a SCM) can be separated into different modules. A modular arrangement allows HPMs of different form factors to be developed, and a SCM may be interconnected to a HPM of any of the different form factors. In some examples, a modular arrangement of resources can be according to a Data Center Modular Hardware System (DC-MHS) specification provided by the Open Compute Project (OCP). In other examples, modular arrangements of resources in a computing environment can be according to other protocols, which can be standardized protocols, open-source protocols, or proprietary protocols.

OCP allows a SCM to be physically connected to any of various different HPMs (including HPMs of different form factors). Since OCP allows a given electronic module to be connected to any other electronic module, to conform with OCP, some processes that ensure trust between electronic modules are not implemented, which can raise security issues between SCMs and HPMs. For example, a HPM may be initially connected to a first SCM. The first SCM may then be disconnected from the HPM, and a different second SCM is connected to the HPM (effectively, a swap of SCMs is performed by switching a connection of the HPM from the first SCM to the second SCM). In another example of a SCM swap, a SCM may initially be connected to a first HPM. At a later time, the SCM may be disconnected from the first HPM and connected to a second HPM.

In either case, after a SCM swap, a HPM may be managed by a second SCM that is different from a first SCM that was initially paired with the HPM. After the SCM swap, the HPM may be managed using a management controller (e.g., a BMC) on the second SCM. In some cases, the SCM swap may be performed by a person with malicious intent (referred to as a “bad actor”). In other cases, the SCM swap may be performed by mistake. After the SCM swap, the second SCM may perform unauthorized actions with respect to the HPM. For example, the second SCM may retrieve sensitive information from the HPM or may introduce malware or otherwise corrupt the HPM. The bad actor (or another person) can then disconnect the second SCM from the HPM (and possibly reconnect the second SCM to another HPM). Since security logs are stored on the second SCM, after the second SCM is disconnected from the HPM, it can be difficult to determine, as part of forensic analysis of the HPM, how the unauthorized actions were performed with respect to the HPM. In a computing environment that supports deployment of HPMs associated with different parties, the ability to swap a SCM to different HPMs may allow the SCM initially connected to a HPM associated with a first party (e.g., a first organization or a first user) to be swapped to a HPM associated with a different second party to perform the unauthorized actions with respect to the HPM associated with the second party.

In accordance with some implementations of the present disclosure, a security module is used to perform a secure initialization of a processor module based on information set in the processor module during a security module-processor module binding process, where the secure initialization of the processor module fails if a security module swap is detected (i.e., a security module that set the information in the processor during the security module-processor module binding process is different from the security module performing the secure initialization). In some examples, a first security module (e.g., a first SCM) includes a connector interface to removably connect to a processor module (e.g., a HPM). The first security module includes a controller (e.g., a BMC) that performs a secure initialization workflow for securely initializing the processor module. The secure initialization workflow includes the controller on the first SCM retrieving information (e.g., a random number) stored at the processor module, where the information is set by a second security module when binding the second security module with the processor module. Note that the first security module may be the same as or different from the second security module. If the first security module is the same as the second security module, then that indicates that a swap of the first security module to the processor module has not occurred and the secure initialization workflow may succeed if certain conditions of the secure initialization workflow are satisfied. However, if the first security module is different from the second security module, then that indicates that a swap of the first security module to the processor module has occurred, and the secure initialization workflow will fail. The secure initialization workflow includes the controller of the first security module reading a first authentication key from a memory of the first security module; computing a second authentication key based on the information retrieved from the processor module, and determining whether to allow an initialization of the processor module based on comparing the first authentication key with the second authentication key.

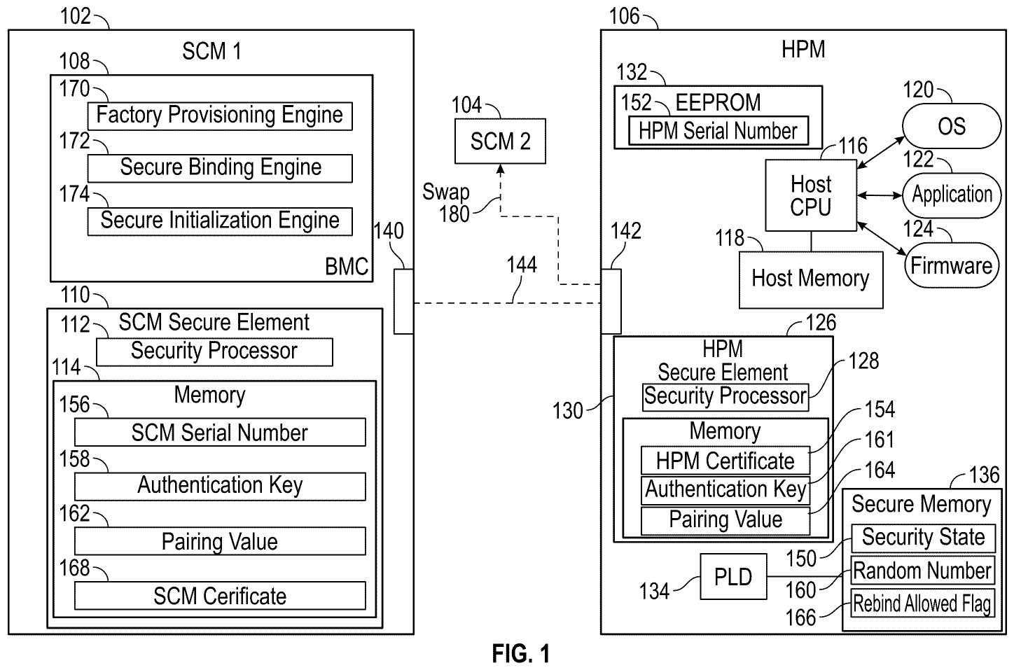

FIG. 1 is a block diagram of an example arrangement that includes a first SCM 102, a second SCM 104, and a HPM 106. Although FIG. 1 shows an example with SCMs and a HPM, in other examples, techniques or mechanisms can be applied to other types of security modules and processor modules. A SCM includes management and security subsystems to perform management tasks and security tasks for a HPM to which the SCM is connected.

A SCM and a HPM may be part of a larger computing system. Examples of a computing system can include any or some combination of the following: a computer (e.g., a desktop computer, a server computer, or another type of computer), a communication node (e.g., a switch, a router, a gateway, or another type of device that supports communications), a storage system, a household appliance, a vehicle, or any other type of electronic device.

The SCM 102 includes a BMC 108 and a SCM secure element 110 that includes a security processor 112 and a memory 114. The SCM 104 similarly includes a BMC and a secure element (not shown). The BMC 108 is an example of a management controller to perform management tasks for a processor module such as the HPM 106. The secure element 110 is an example of a security subsystem to perform security tasks for the processor module. The memory 114 may be implemented using a nonvolatile memory, which can include any or some combination of the following: a flash memory device or any other type of nonvolatile memory device. A nonvolatile memory refers to a memory that can maintain its content even if power were to be removed from the memory.

A secure element can perform various security tasks, including any or some combination of the following as examples: authentication, supporting firmware update, performing key management including key storage, or other security tasks. A “security processor” of a secure element can be implemented using hardware processing circuitry such as a microcontroller, a programmable integrated circuit, a programmable gate array, or another hardware processing circuit. In the SCM 102, the security processor 112 in the SCM secure element 110 is separate from a BMC processor (not shown) in the BMC 108. A memory can be implemented with one or more memory devices. Examples of memory devices can include any or some combination of the following: a dynamic random access memory (DRAM) device, a static random access memory (SRAM) device, a flash memory device, or any other type of memory device.

The HPM 106 includes a host CPU 116 and a host memory 118. The host CPU 116 can include one or more processors, which form a processing resource of the HPM 106. The host CPU 116 executes primary machine-readable instructions of the HPM 106. Examples of primary machine-readable instructions can include any or some combination of the following: an operating system (OS) 120, an application program 122, system firmware 124 (e.g., Basic Input/Output System (BIOS) code or Universal Extensible Firmware Interface (UEFI) code), or other software or firmware. A processor can include a microprocessor, a core of a multi-core microprocessor, a microcontroller, a programmable integrated circuit, a programmable gate array, or another hardware processing circuit.

During execution of a program (e.g., the OS 120, the application program 122, the system firmware 124, or any other software or firmware) by the host CPU 116, information (e.g., machine-readable instructions and data) associated with the execution of the program may be stored in the host memory 118.

The HPM 106 further includes a HPM secure element 126, which includes a security processor 128 and a memory 130 (e.g., a nonvolatile memory). The HPM 106 also includes an electrically erasable and programmable read-only memory (EEPROM) device 132, which is an example of a nonvolatile memory. In other examples, another type of a nonvolatile memory may be used, such as a flash memory device, an erasable and programmable read-only memory (EPROM) device, and so forth.

In further examples, the EEPROM 132 may be omitted from the HPM 106. In such examples, data that would be stored in the EEPROM 132 may be stored in the memory 130 of the HPM secure element 126.

The HPM 106 further includes a programmable logic device 134 that is connected to a secure memory 136 (e.g., a nonvolatile memory). The programmable logic device 134 refers to a logic device that has less processing capability than other processing resources that may be present on the HPM 106, such as the host CPU 116 and the security processor 128. In some examples, the programmable logic device 134 can be implemented using any or some combination of the following: a complex programmable logic device (CPLD), a programmable gate array, a programmable integrated circuit, a microcontroller, or any other type of logic device that is capable of executing machine-readable instructions.

The secure memory 136 is secure in the sense that access to data in the secure memory 136 is accessible through the programmable logic device 134 and is not accessible to other entities, such as the host CPU 116. In some examples, the programmable logic device 134 can allow access of data in the secure memory 136 if requested by the HPM secure element 126 in the HPM 106 or by a BMC in a SCM.

Although FIG. 1 shows an example of a HPM with the programmable logic device 134 and the secure memory 136, in other examples, the programmable logic device 134 and the secure memory 136 may be omitted. In such examples, any data stored in the secure memory 136 (as discussed below) can be stored in the memory 130 of the HPM secure element 126.

The SCM 102 includes a connector interface 140 that is able to connect (144) to a respective connector interface 142 of the HPM 106. A “connector interface” can refer to an arrangement of pins, receptacles, or other elements for establishing a connection. The connection can include an electrical connection, an optical connection, or a different type of connection.

The SCM 104 similarly includes a connector interface (not shown) to connect to the HPM 106. As noted above, according to OCP, the SCMs 102 and 104 are connectable to different HPMs, including HPMs of different form factors. A “form factor” of a HPM refers to a physical specification of the HPM, including its size, shape, and/or another physical characteristic.

A computing environment (e.g., a data center, a cloud computing environment, etc.) can include many different HPMs, such as in a large quantity of server computers or other computing systems. In some cases, different HPMs in a computing environment may be associated with different parties. For example, the computing environment may be operated by a service provider, and tenants of the computing environment may use respective HPMs. In some cases, the HPMs may be owned by the tenants. In other cases, the HPMs may be owned by the service provider but leased for use by the tenants.

In the computing environment, HPMs associated with different parties (e.g., tenants) may be physically accessible to personnel at the computing environment. In some cases, a bad actor may swap SCMs with respect to HPMs as part of attempts to perform unauthorized activities with respect to the HPMs. For example, the bad actor may disconnect the SCM 102 from the HPM 106, and connect the SCM 104 to the HPM 106 so that the SCM 104 can be used for an unauthorized access of the HPM 106. The SCM 104 may previously be connected to another HPM. In other cases, swapping of SCMs to different HPMs may be performed by mistake, such as by service personnel when servicing SCMs or HPMs. However, the mistakenly swapped SCMs may still be able to perform unauthorized activities with respect to HPMs.

Techniques or mechanisms according to some examples of the present disclosure can prevent initialization of a HPM when a SCM swap occurs. As noted above, a SCM swap may be performed by a bad actor. The bad actor may have physical access to a facility that includes computing systems with respective different HPMs, possibly associated with different parties. In one example, the bad actor may disconnect a SCM from a HPM, and connect another SCM to the HPM in an attempt to perform an unauthorized access of the HPM. The other SCM may have been previously connected to another HPM, or may have been brought to the facility by the bad actor. In another example, a SCM swap may have been inadvertently performed, such as by service personnel.

In further examples discussed below, in some cases, SCM swaps may be allowed. For example, a first SCM connected to a HPM may be experiencing faults. In such an example, the first SCM can be disconnected from the HPM and sent back to a vendor of the first SCM. The vendor of the first SCM may send back a second SCM as a replacement SCM, which may be connected to the HPM. This type of a SCM swap is allowed by techniques or mechanisms according to some implementations of the present disclosure.

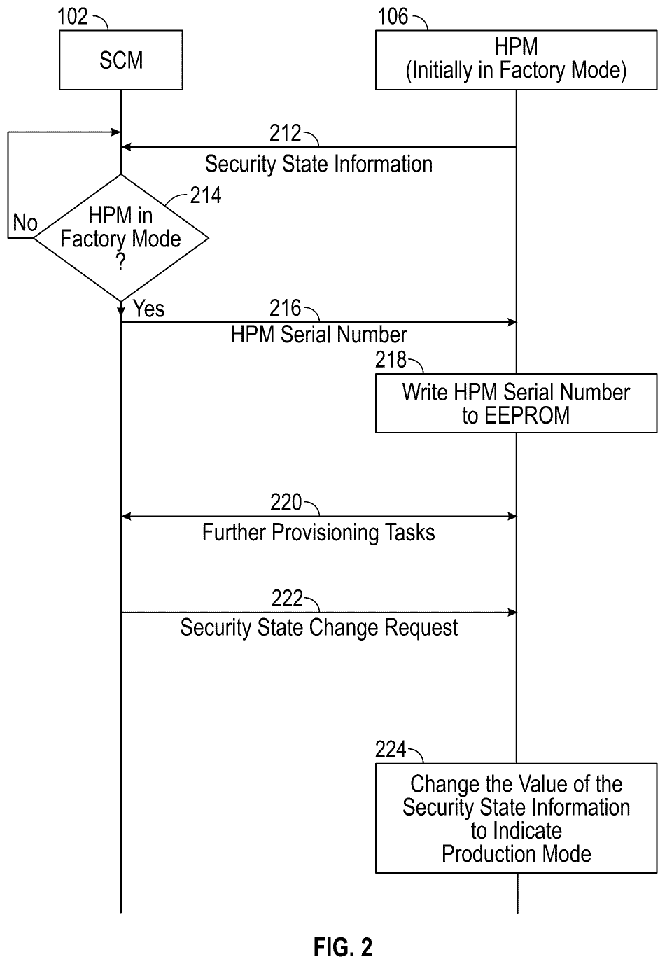

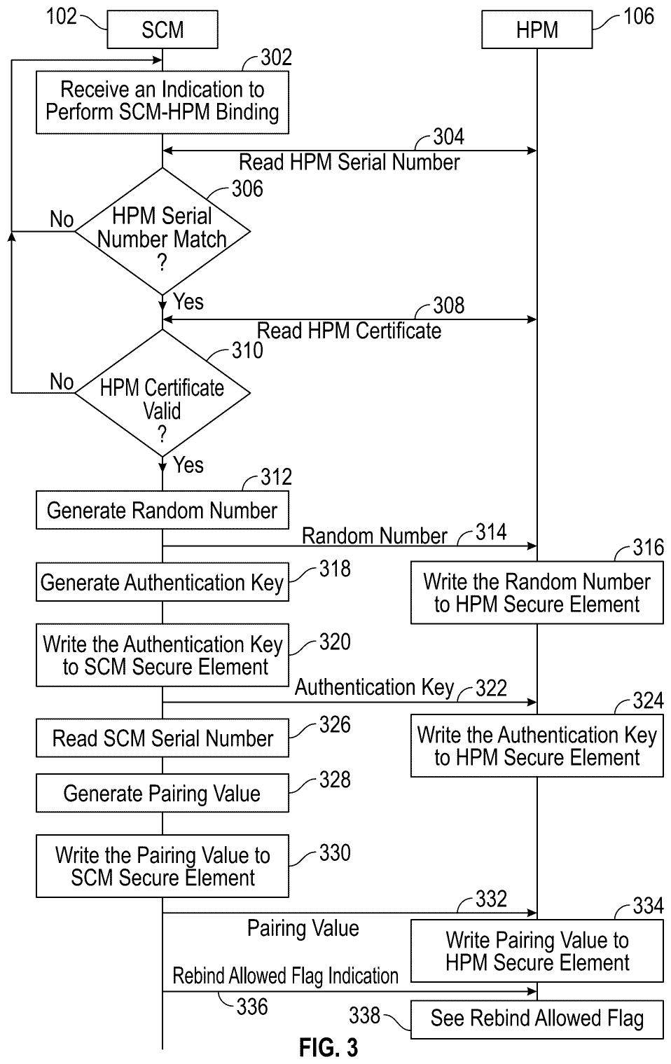

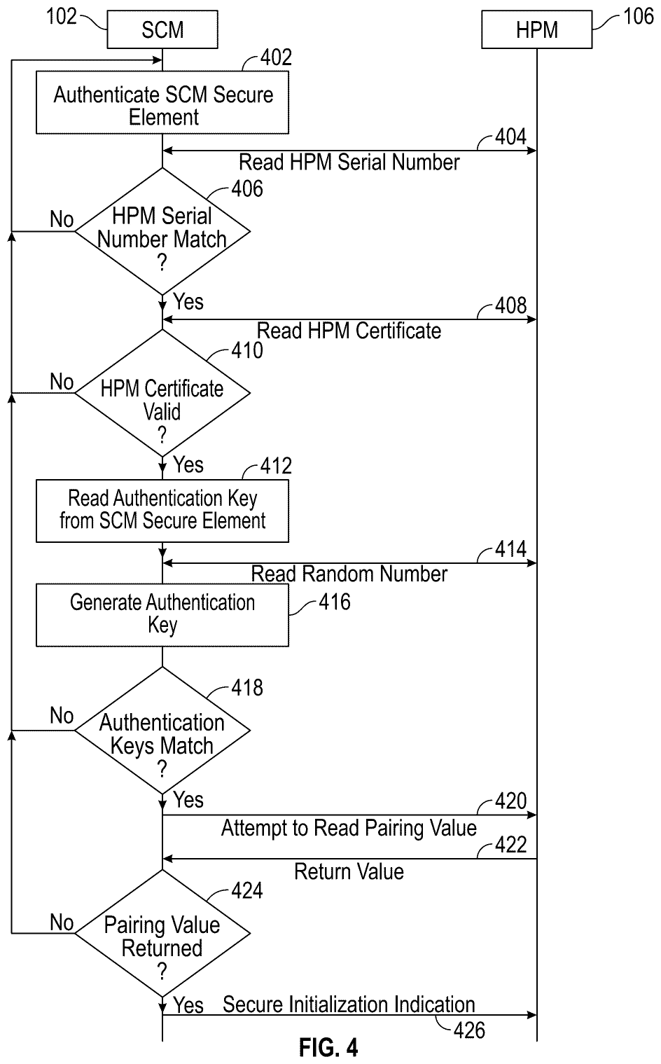

In accordance with some implementations of the present disclosure, a secure binding process and a secure initialization process can be implemented to prevent the initialization of a HPM when a SCM swap occurs if the SCM swap is not authorized. As discussed further below, a SCM swap may be authorized in contexts where a first SCM that is defective is swapped with a second SCM. The secure binding process can be performed by a secure binding engine 172 in the BMC 108 (discussed in FIG. 3), and the secure initialization process can be performed by a secure initialization engine 174 in the BMC 108 (discussed in FIG. 4). The BMC 108 further includes a factory provisioning engine 170 to perform a factory provisioning process (discussed in FIG. 2).

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

The ensuing discussion refers to various processes depicted in FIG. 2 to FIG. 5. Although each of FIG. 2 to FIG. 5 depicts a specific sequence of tasks, note that in other examples, the tasks may be performed in a different order, some tasks may be omitted, and other tasks may be added. In the discussion of these processes, reference is also made to FIG. 1.

FIG. 2 is a flow diagram of a factory provisioning process to perform factory provisioning of the HPM 106, in accordance with some examples of the present disclosure. The factory provisioning process can be performed between the SCM 102 and the HPM 106 during a stage of manufacturing of a computing system that includes the SCM 102 and the HPM 106. Interactions between the SCM 102 and the HPM 106 may be performed through the connection 144 (FIG. 1) between the SCM 102 and the HPM 106. For example, factory provisioning can be performed during a board manufacturing stage (or another stage) of manufacturing, in which a circuit board (which includes the HPM 106) is integrated into a chassis of the computing system. In other examples, the factory provisioning process can be performed during another manufacturing stage.

The SCM 102 used in the factory provisioning process is a “golden” SCM, which refers to a SCM that has gone through one manufacturing cycle such that any machine-readable instructions (including firmware and software) on the SCM and any configuration settings are known machine-readable instructions and configuration settings. The golden SCM 102 has not been released outside of a manufacturing facility, and thus is considered a trusted SCM since it is unlikely the SCM 102 has been tampered with.

In the factory provisioning process of FIG. 2, it is assumed that the HPM 106 is a pristine HPM, which refers to a HPM that is in a factory mode. The pristine HPM 106 is a “blank” HPM that does not contain information for operation of the HPM 106 in the memories of the HPM 106, including the EEPROM 132, the memory 130 of the HPM secure element 126, and the secure memory 136.

However, the secure memory 136 of the HPM 106 in the factory mode does store security state information 150. The security state information 150 can be set to different values to represent different modes of the HPM 106. The modes of the HPM 106 include a factory mode and a production mode (and possibly other modes). The security state information 150 if set to a first value indicates that the HPM 106 is in the factory mode, while the security state information 150 if set to a different second value indicates that the HPM 106 is in the production mode. The factory mode of the HPM 106 is associated with manufacturing of the HPM 106. The production mode of the HPM 106 indicates that the HPM 106 is ready for use by users, and can be released to customers. In the factory provisioning process of FIG. 2, it is assumed that the security state information 150 is set to the first value to indicate the factory mode.

The SCM 102 may also have a factory mode and a production mode. The SCM 102 is set in the production mode to perform the factory provisioning of the HPM 106 according to FIG. 2.

Tasks of the BMC 108 in FIG. 2 may be performed by the factory provisioning engine 170 of the BMC 108, for example. In the factory provisioning process of FIG. 2, the BMC 108 receives (at 212) the security state information 150 from the HPM 106. In some examples, the BMC 108 can issue a read request to the programmable logic device 134 in the HPM 106 to read the security state information 150 in the secure memory 136. A “request” can refer to a command, a message, an information element, or any other indicator of an action that is requested of a target. In response to the read request, the programmable logic device 134 retrieves the security state information 150 from the secure memory 136 and sends the security state information 150 to the BMC 108.

The BMC 108 determines (at 214), based on the security state information 150, whether the HPM 106 is in the factory mode. This determination is based on the value of the security state information 150 (e.g., the first value of the security state information 150 indicates the factory mode). If the HPM 106 is not in the factory mode, then the factory provisioning process of FIG. 2 ends (the “No” branch of decision diamond 214), and the HPM 106 is not provisioned further.

However, if the BMC 108 determines (at 214) that the HPM 106 is in the factory mode, the BMC 108 sends (at 216) a HPM serial number to the HPM 106. In some examples, the HPM serial number is a serial number assigned to a circuit board of the HPM 106. The HPM serial number can be received by the BMC 108 from an administrator or another entity (a program or a machine). This received HPM serial number may be stored by the BMC 108 in a memory of the BMC 108 (this HPM serial number stored by the BMC 108 is referred to as a “BMC-stored HPM serial number”). Although reference is made to use of serial numbers in the present discussion, it is noted that other types of identifiers can be used in other examples. More generally, the BMC 108 can send a HPM identifier to the HPM 106. An “identifier” can include any value that can be used to identify a component, such as the HPM 106.

The HPM 106 writes (at 218) the HPM serial number (e.g., 152 in FIG. 1) to the EEPROM 132 of the HPM 106. The HPM Ser. No. 152 (or another HPM identifier) once set does not change in the HPM 106. In some examples, the BMC 108 can issue a write request to the HPM 106 to write the HPM Ser. No. 152 to the EEPROM 132.

Further factory provisioning tasks can be performed (at 220) between the SCM 102 and the HPM 106. Following the further provisioning tasks, the BMC 108 sends (at 222), to the programmable logic device 134 in the HPM 106, a security state change request to change the security state of the HPM 106 from the factory mode to the production mode. In response to the security state change request, the programmable logic device 134 changes (at 224) the value of the security state information 150 (e.g., from a first value to a second value) to indicate the production mode.

At this point, the HPM 106 is in the production mode and can be released to the field for use by users.

FIG. 3 is a flow diagram of a secure binding process between the SCM 102 and the HPM 106, in accordance with some examples of the present disclosure. A “binding process” pairs a SCM with a HPM by creating specific information stored at the SCM and the HPM so that the SCM can securely initialize the HPM. “Initializing” a HPM can refer to starting up the HPM, such as booting the HPM from a low power state or a reset state. The booting of the HPM includes configuring settings of components of the HPM, and loading the OS of the HPM (e.g., the OS 120 of FIG. 1).

The secure binding process of FIG. 3 can be performed during a manufacturing stage that is after the manufacturing stage in which the factory provisioning process of FIG. 2 was performed. For example, the secure binding process may be performed during a component integration stage (or another stage) of manufacturing, in which a full assembly of a computing system, testing of components of the computing system, and integration of software and firmware are performed. In FIG. 3, the HPM 106 is in the production mode. The SCM 102 is also in the production mode.

Tasks of the BMC 108 in FIG. 3 can be performed by the secure binding engine 172 of the BMC 108 in the SCM 102. The BMC 108 receives (at 302) a binding indication to perform binding of the SCM 102 and the HPM 106. In some examples, the indication can be in the form of a command, a message, an information element, or any other type of indicator. The indication can be received from a user device associated with a user (e.g., an administrator), such as through an interface of the BMC 108.

The interface of the BMC 108 may include an application programming interface (API), such as a Redfish API that is according to the Distributed Management Task Force (DMTF) Redfish standard, which supports the management of devices such as server computers, storage systems, networking equipment, or other devices. In other examples, interface of the BMC 108 may include a REpresentational State Transfer (REST) API, or any other type of interface through which an entity external of the BMC 108 can communicate with the BMC 108.

The BMC 108 initiates the secure binding process in response to the binding indication that is received by the BMC 108. The remaining tasks below are part of the binding process according to some examples.

The BMC 108 reads (at 304) the HPM serial number 152 from the HPM 106. For example, the BMC 108 can send, to the HPM 106, a request to read a HPM serial number of the HPM 106. In response to the read request, the HPM 106 retrieves the HPM serial number 152 from the EEPROM 132, and the HPM 106 sends the HPM serial number 152 to the BMC 108.

The BMC 108 determines (at 306) whether the HPM serial number 152 received from the HPM 106 matches the BMC-stored HPM serial number. If not, then the binding process stops (the “No” branch of the decision diamond 306). The received HPM Ser. No. 152 not matching the BMC-stored HPM serial number indicates that the SCM 102 is not associated with the HPM 106 and thus should not be bound to the HPM 106.

However, if the received HPM serial number matches the BMC-stored HPM serial number, the BMC 108 reads (at 308) a HPM certificate from the HPM 106. For example, the BMC 108 can send a request to read the HPM certificate from the HPM 106. The HPM certificate is a digital certificate that is used for authenticating the HPM 106. FIG. 1 shows a HPM certificate 154 stored in the memory 130 of the HPM secure element 126 of the HPM 106. In response to the request to read the HPM certificate, the security processor 128 retrieves the HPM certificate 154 from the memory 130, and the security processor 128 sends the HPM certificate 154 to the BMC 108.

The BMC 108 determines (at 310) whether the received HPM certificate 154 is valid, such as based on a digital signature of the received HPM certificate 154. If the received HPM certificate 154 is not valid, the binding process stops (the “No” branch of the decision diamond 310). However, if the received HPM certificate 154 is valid, the BMC 108 proceeds with further tasks of the secure binding process.

The BMC 108 generates (at 312) a random number. For example, the BMC 108 may include a pseudorandom number generator to generate the random number. The BMC 108 sends (at 314) the random number to the HPM 106. In response to receiving the random number, the programmable logic device 134 writes (at 316) the random number to the secure memory 136 in the HPM 106. FIG. 1 shows a random number 160 written to the secure memory 136 of the HPM 106.

The BMC 108 generates (at 318) an authentication key based on the random number and the HPM Ser. No. 152. For example, the random number and the HPM Ser. No. 152 can be input to a function (e.g., a cryptographic hash function or any other type of function). Based on the random number and HPM Ser. No. 152 (and possibly other information), the function produces the authentication key (which is a hash value if the function is a cryptographic hash function), as follows:
Authentication Key=Function(Random Number, HPM Serial Number).

The BMC 108 writes (at 320) the authentication key to the memory 114 of the SCM secure element 110 in the SCM 102. FIG. 1 shows an authentication key 158 written to the memory 114. The authentication key 158 written to the memory 114 may be a “sealed” authentication key, which has been encrypted using an encryption key.

The BMC 108 sends (at 322) the authentication key to the HPM 106. In response to receiving the authentication key, the security processor 128 of the HPM secure element 126 writes (at 324) the authentication key received from the BMC 108 to the memory 130 of the HPM secure element 126. FIG. 1 shows an authentication key 161 written to the memory 130 of the HPM secure element 126.

Further, the BMC 108 reads (at 326) a SCM serial number 156 (or another SCM identifier) of the SCM 102. The SCM serial number 156 may be read from the memory 114 of the SCM secure element 110 in the SCM 102, for example. The BMC 108 can access data in the memory 114 of the SCM secure element 110 by issuing an access request (e.g., a read request or write request) to the security processor 112 of the SCM secure element 110.

The BMC 302 also generates (at 328) a pairing value based on the HPM serial number 152 received from the HPM 106 and the SCM serial number 156 of the SCM 102. For example, the HPM serial number 152 and the SCM serial number 156 can be input to a function (e.g., a cryptographic hash function or another function). Based on the input information, the function produces the pairing value (which is a pairing hash if the function is a cryptographic hash function), as follows:

$$Pairing Value = Function ( HPM Serial Number , SCM Serial Number ) .$$

The BMC 108 writes (at 330) the pairing value to the memory 114 of the SCM secure element 110. FIG. 1 shows a pairing value 162 written to the memory 114.

The BMC 108 sends (at 332) the pairing value to the HPM 106. In response to receiving the pairing value, the security processor 128 of the HPM secure element 126 in the HPM 106 writes (at 334) the pairing value to the memory 130 of the HPM secure element 126. FIG. 1 shows a pairing value 164 written to the memory 130. The pairing value 164 stored at the HPM 106 is used as part of the secure initialization process (FIG. 4).

In some examples, the BMC 108 also sends (at 336) an indication to the HPM 106 to set a Rebind Allowed flag to an “Allowed” value (e.g., “1” or “0”), to indicate that replacement of the SCM 102 with a different SCM for the HPM 106 is allowed (such as when the SCM 102 experiences a fault and has to be replaced). The Rebind Allowed flag can be in the form of a field or other indicator.

In response to the indication, the programmable logic device 134 sets (at 338) the Rebind Allowed flag to the “Allowed” value. The Rebind Allowed flag can also have a “Disallowed” value (e.g., “0” or “1”), which indicates that replacement of the SCM 102 with a different SCM for the HPM 106 is not allowed. FIG. 1 shows a Rebind Allowed flag 166 stored in the secure memory 136 in the HPM 106.

FIG. 4 is a flow diagram of a secure initialization process according to some examples of the present disclosure, which can be performed after the manufacture of a computing system including the HPM 106 is complete and the computing system has been released for use by customers. For example, the computing system may be deployed in a computing environment. The secure initialization process is performed between the SCM 102 and the HPM 106. Tasks of the BMC 108 in the SCM 102 for the secure initialization process can be performed by the secure initialization engine 174. In FIG. 4, the HPM 106 is in the production mode. The SCM 102 is also in the production mode.

The secure initialization process may be initiated by the BMC 108 when the BMC 108 first receives power, such as from an auxiliary power supply. The auxiliary power supply can include a battery, for example, and the auxiliary power supply is separate from a main power supply used to power the HPM 106. At this stage, the BMC 108 may be powered, but power may not yet be available to certain components of the HPM 106, such as the host CPU 116 and the host memory 118. However, power may be available to the EEPROM 132, the HPM secure element 126, the programmable logic device 134, and the secure memory 136 of the HPM 106. This power to the above components of the HPM 106 may be supplied from the auxiliary power supply or from a different power supply.

The BMC 108 authenticates (at 402) the SCM secure element 110 in the SCM 102. For example, the secure memory 114 in the SCM secure element 110 stores a SCM certificate 168. To authenticate the SCM secure element 110, the BMC 108 can check the digital signature of the SCM certificate 168 using a certificate authority (CA) certificate available to the BMC 108. If the BMC 108 is unable to authenticate the SCM secure element 110, then the BMC 108 does not proceed with the secure initialization process. The remaining tasks of FIG. 3 are performed assuming that the BMC 108 has successfully authenticated the SCM secure element 110.

The BMC 108 reads (at 404) the HPM serial number 152 from the EEPROM 132 in the HPM 106. The BMC 108 determines (at 406) whether the HPM serial number 152 received from the HPM 106 matches the BMC-stored HPM serial number. If not, then the secure initialization process stops (the “No” branch of the decision diamond 406). The received HPM serial number 152 not matching the BMC-stored HPM serial number indicates that the SCM 102 is not associated with the HPM 106 and thus should not be allowed to initialize the HPM 106.

However, if the received HPM serial number 152 matches the BMC-stored HPM serial number, the BMC 108 reads (at 408) the HPM certificate 154 from the HPM secure element 126 in the HPM 106. The BMC 108 determines (at 410) whether the HPM certificate 154 is valid, such as based on a digital signature of the received HPM certificate 154. If the HPM certificate 154 is not valid, the secure initialization process stops (the “No” branch of the decision diamond 410). However, if the received HPM certificate 154 is valid, the BMC 108 proceeds with further tasks of the secure initialization process.

The BMC 108 reads (at 412) the authentication key 158 from the memory 114 of the SCM secure element 110 in the SCM 102. Note that the authentication key 158 stored in the SCM secure element 110 was generated (at 320) by the BMC 108 during the secure binding process of FIG. 3. If the authentication key 158 in the memory 114 of the SCM secure element 110 is sealed (encrypted), then the BMC 108 decrypts the sealed authentication key 158 to produce a cleartext version of the authentication key 158.

The BMC 108 also reads (at 414) the random number 160 from the secure memory 136 in the HPM 106. For example, the BMC 108 can issue a read request to the HPM 106 for the random number 160. In response to the read request, the programmable logic device 134 retrieves the random number 160 from the secure memory 136, and the programmable logic device 134 sends the random number 160 to the BMC 108.

The BMC generates (at 416) an authentication key based on the random number 160 and the HPM serial number 152, which are both received from the HPM 106. For example, the HPM serial number 152 and the random number 160 are input to a function that produces the authentication key, as follows:

$$Authentication Key = Function ( Random Number , HPM Serial Number ) .$$

The generation of the authentication key (at 416) as part of the secure initialization process corresponds to the generation of the authentication key (at 318) as part of the secure binding process.

The BMC 108 determines (at 418) whether the generated authentication key (generated at 416) matches the stored authentication key 158 that is stored in the SCM secure element 110. The authentication key 158 was written to the SCM secure element 110 (at 320 in the secure binding process of FIG. 3).

If the generated authentication key does not match the stored authentication key 158, then that indicates that the SCM 102 was not bound to the HPM 106, such as due to a SCM swap. As a result, if the authentication keys do not match, the secure initialization process stops (the “No” branch of decision diamond 418). The BMC 108 can perform a remediation action, such as logging an indication of a secure initialization error and sending an alert to a target entity (e.g., a human, a program, or a machine).

However, If the authentication keys match, the BMC 108 attempts to read (at 420) the pairing value 164 from the HPM secure element 126 in the HPM 106. For example, the BMC 108 can issue a read request to the HPM 106 for the pairing value 164. This read request can include an authentication key provided by the BMC 108, which can be the authentication key generated (at 416) or the authentication key 158 retrieved from the SCM secure element 110. The authentication key provided by the BMC 108 with the read request to read the pairing value 164 is to be used as a secret (e.g., a password or another credential) for access of the pairing value 164. In response to the read request including the provided authentication key, the security processor 128 of the HPM secure element 126 determines whether the authentication key 158 in the read request matches the authentication key 161 stored in the HPM secure element 126.

The security processor 128 sends (at 422) a return value to the BMC 108, where the return value depends on whether the provided authentication key in the read request matches the authentication key 161 stored in the HPM secure element 126. If the provided authentication key matches the authentication key 161, the security processor 128 sends the pairing value 164 as the return value to the BMC 108. However, if the provided authentication key does not the authentication key 161, the security processor 128 sends an error value (e.g., a null value or some other predefined value indicating an error) as the return value to the BMC 108.

The BMC 108 determines (at 424) whether the HPM 106 returned the pairing value 164. If the pairing value 164 is received from the HPM 106, then that indicates successful authentication between the BMC 108 and the HPM 106 (which indicates that the provided authentication key is valid). As a result, the BMC 108 can send (at 426) a secure initialization indication (e.g., a signal, a command, an information element, or any other indicator) to the programmable logic device 134 in the HPM 106 to proceed with the secure initialization process, which can include booting the HPM 106. The secure initialization indication causes the programmable logic device 134 to initiate the booting of the HPM 106. The BMC 108 can also activate the main power supply for the HPM 106 to supply power to the remaining components of the HPM 106, such as the host CPU 116 and the host memory 118.

If the pairing value 164 is not received from the HPM 106 (and instead an error value was received), then that indicates unsuccessful authentication between the SCM 102 and the HPM 106, possibly due to a SCM swap. In this latter case, the secure initialization process is not allowed to proceed (the “No” branch of the decision diamond 424). Note that the secure initialization indication is not sent by the BMC 108 to the HPM 106, so the HPM 106 would not initialize (e.g., boot).

For example, in FIG. 1, the SCM 102 and the HPM 106 may have been bound using the secure binding process of FIG. 3. However, at a later time, the SCM 102 is disconnected from the HPM 106, and a SCM swap (180) is performed in which the SCM 104 is connected to the HPM 106 in place of the SCM 102. In such a scenario, the initialization of the HPM 106 can be prevented based on the secure initialization process of FIG. 4.

In some examples, whether or not to allow initialization of a HPM due to a detected SCM swap can be according to an initialization policy set by a service provider. For example, the initialization policy can specify that the initialization of a HPM is to be blocked if a SCM swap is detected. This may be useful in scenarios where multiple tenants are associated with different HPMs in a computing environment. In other cases, the initialization policy can specify that the initialization of a HPM is to be allowed even if a SCM swap is detected.

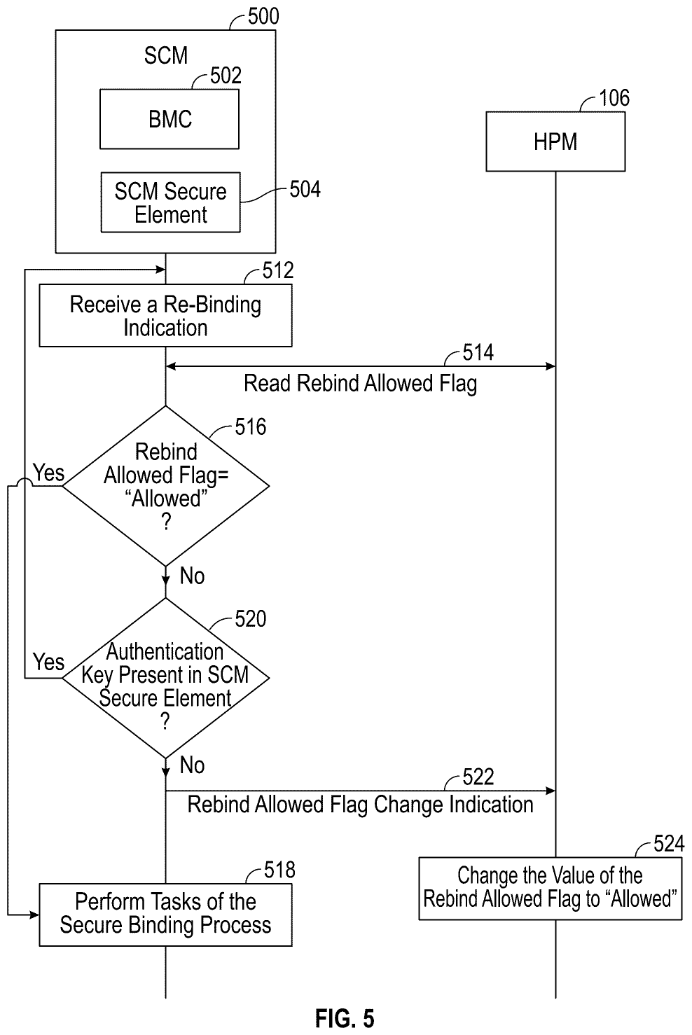

FIG. 5 is a flow diagram of a secure SCM replacement process according to some examples of the present disclosure. In the example of FIG. 5, it is assumed that a SCM 500 is a SCM that is to replace another SCM (e.g., 102), which may have experienced a fault and thus has to be replaced. A fault can include a hardware fault or a fault in machine-readable instructions. The SCM 500 can be referred to as a “replacement SCM.”

The replacement SCM 500 includes a BMC 502 and a SCM secure element 504, which are similar to the BMC 108 and the SCM secure element 110 of the SCM 102 of FIG. 1, for example.

The replacement SCM 500 does not store an authentication key, such as the authentication key 158 stored in the SCM secure element 110 in the SCM 102 of FIG. 1. The absence of an authentication key in the SCM secure element 504 can be used as a condition to allow changing a value of the Rebind Allowed flag 166 in the HPM 106 (as discussed further below).

The replacement SCM 500 stores the HPM serial number that was provided to the HPM 106 by the SCM 102 during the factory provisioning process of FIG. 2. This HPM serial number may be manually provided to the replacement SCM 500, such as by a technician or another user.

In the secure SCM replacement process of FIG. 5, the HPM 106 is in the production mode, and the SCM 500 is also in the production mode. The BMC 502 in the replacement SCM 500 receives (at 512) a re-binding indication to perform a SCM-HPM rebinding. The re-binding indication can be received from a user device associated with a user (e.g., a technician or another user), such as through an interface of the BMC 502.

In response to the re-binding indication, the BMC 502 reads (at 514) the Rebind Allowed flag 166 from the secure memory 136 of the HPM 106. In some examples, the BMC 502 can issue a read request to the programmable logic device 134 in the HPM 106 to read the Rebind Allowed flag 166 in the secure memory 136. In response to the read request, the programmable logic device 134 retrieves the Rebind Allowed flag 166 from the secure memory 136 and sends the Rebind Allowed flag 166 to the BMC 502.

The BMC 502 determines (at 516) whether the Rebind Allowed flag 166 has the “Allowed” value. If the Rebind Allowed flag 166 has the “Allowed” value, the BMC 502 proceeds to perform (at 518) tasks 304 to 338 of the secure binding process of FIG. 3. This secure binding process binds the replacement SCM 500 with the HPM 106.

However, if the Rebind Allowed flag 166 does not have the “Allowed” value (i.e., is set to the “Disallowed” value), the BMC 502 attempts to change the value of the Rebind Allowed flag 166 from the “Disallowed” value to the “Allowed” value. The BMC 502 determines (at 520) whether an authentication key is present in the SCM secure element 504. If the authentication key is present, then that indicates the replacement SCM 500 is not a valid replacement SCM (and in fact may be a SCM swapped by a bad actor), then the secure SCM replacement process stops (the “Yes” branch of the decision diamond 516).

If the BMC 502 determines (at 520) that no authentication key is present in the SCM secure element 504, the BMC 502 sends (at 522) a change indication to the HPM 106 to change the value of the Rebind Allowed flag 166. In response to the change indication, the programmable logic device 134 in the HPM 106 changes (at 524) the value of the Rebind Allowed flag 166 to the “Allowed” value. The BMC 502 then proceeds to perform (at 518) tasks 304 to 338 of the secure binding process of FIG. 3. This secure binding process binds the replacement SCM 500 with the HPM 106.

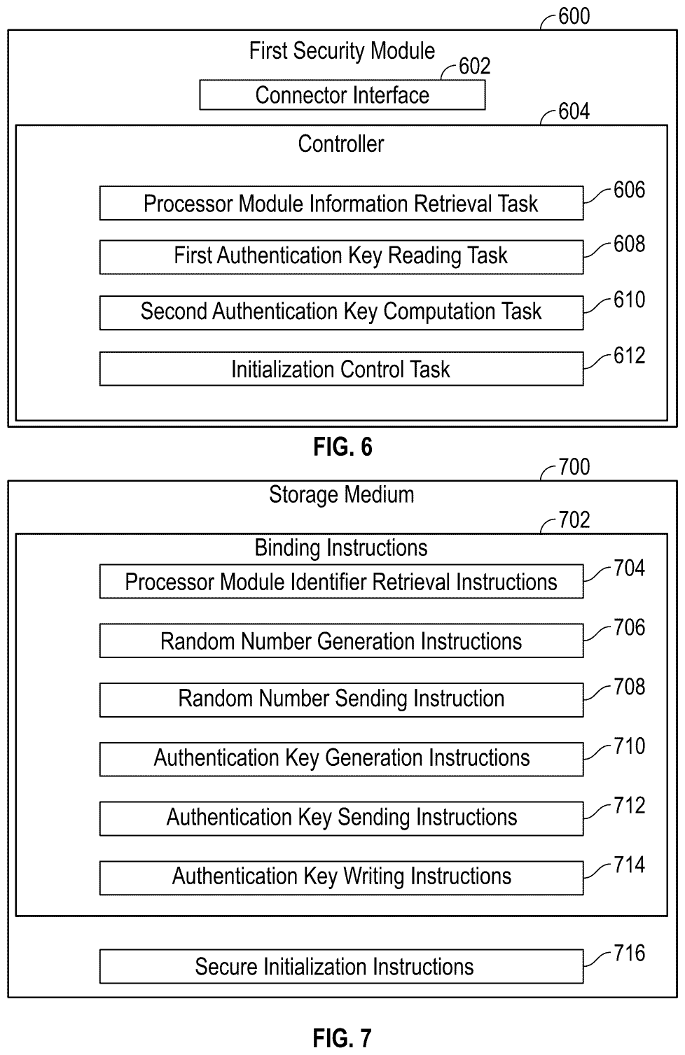

FIG. 6 is a block diagram of a first security module 600 according to some examples of the present disclosure. For example, the first security module 600 includes a SCM.

The first security module 600 includes a connector interface 602 (e.g., 140 in FIG. 1) to removably connect to a processor module (e.g., a HPM). In some examples, the first security module 600 can connect over a bus or any other type of input/output (I/O) interconnect.

The first security module 600 includes a controller 604 to perform various tasks. An example of the controller 604 is a BMC.

The tasks of the controller 604 include a processor module information retrieval task 606 to retrieve information stored at the processor module. The information may include a random number, a processor module identifier (e.g., a serial number of the processor module), and/or other information. The random number may be set by a second security module during a binding process (e.g., FIG. 3) of the second security module with the processor module. The processor module identifier may be set during a factory provisioning process (e.g., FIG. 2) of the processor module. The second security module may be the same as the first security module 600 if a security module swap has not occurred. In examples where a security swap has occurred, the security module is different from the first security module.

The tasks of the controller 604 include a first authentication key reading task 608 to read a first authentication key from a memory of the first security module 600. The first authentication key was generated by the first security module 600 and written to the memory during a binding process between the first security module 600 and a processor module.

The tasks of the controller 604 include a second authentication key computation task 610 to compute a second authentication key based on the information retrieved from the processor module. For example, the second authentication key is derived based on computing a value based on the random number and the processor module identifier retrieved from the processor module. As a more specific example, the random number and the processor module identifier retrieved from the processor module can be input to a hash function to derive a hash value used to produce the second authentication key.

The tasks of the controller 604 include an initialization control task 612 to determine whether to allow an initialization of the processor module based on the first authentication key and the second authentication key. For example, if the first authentication key and the second authentication key match, the controller 604 can send an indication to the processor module to cause initialization of the processor module. If the first authentication key and the second authentication key are different from one another, then the controller 604 does not allow initialization of the processor module. A mismatch of the second authentication key and the first authentication key indicates that the first security module is different from the second security module, which can occur as a result of a security module swap.

In some examples, the serial number of the processor module is set while the processor module is in a factory mode. The serial number of the processor module does not change after the serial number is set. If a processor swap occurred, then the serial number is set by the second security module that is different from the first security module.

In some examples, after the setting of the serial number, the processor module is transitioned to a production mode. The information (including the random number and the processor module identifier) is retrieved by the first security module 600 from the processor module in the production mode.

In some examples, the controller 604 requests, from the processor module, a pairing value generated by the second security module based on first information (e.g., a serial number) of the processor module and second information (e.g., a serial number) of the second security module. The request includes a controller-provided authentication key sent from the controller to the processor module, where the controller-provided authentication key can include the first authentication key or the second authentication key. The controller receives the pairing value from the processor module in response to the request, where the receipt of the pairing value indicates a validity of the controller-provided authentication key. For example, the controller-provided authentication key can be used as a secret (e.g., a password or another credential) for accessing the pairing value stored at the processor module.

In some examples, the pairing value includes a hash value derived from applying a hash function on the first information and the second information.

FIG. 7 is a block diagram of a non-transitory machine-readable or computer-readable storage medium 700 storing machine-readable instructions that upon execution cause a security module to perform various tasks. For example, the security module includes a SCM.

The machine-readable instructions include binding instructions 702 to bind the security module to a processor module. As part of the binding process to bind the security module to the processor module, the binding instructions 702 include processor module identifier retrieval instructions 704 to retrieve, from the processor module, a processor module identifier that identifies the processor module. For example, the processor module identifier includes a serial number.

The binding instructions 702 include random number generation instructions 706 to generate a random number. The binding instructions 702 include random number sending instructions 708 to send the random number from the security module to the processor module, which causes the processor module to store the random number, such as in the secure memory 136 (FIG. 1).

The binding instructions 702 include authentication key generation instructions 710 to generate an authentication key based on the processor module identifier and the random number. For example, the processor module identifier and the random number can be input to a hash function, which outputs the authentication key based on the processor module identifier and the random number.

The binding instructions 702 include authentication key sending instructions 712 to send the authentication key from the security module to the processor module. The sending of the authentication key to the processor module causes the authentication key to be stored at the processor module, such as in the HPM secure element 126 (FIG. 1).

The binding instructions 702 include authentication key writing instructions 714 to write the authentication key to a memory of the security module. For example, the memory of the security module may be part of the SCM secure element 110 (FIG. 1).

The machine-readable instructions in the storage medium 700 further include secure initialization instructions 716 to perform a secure initialization process with the processor module that uses the authentication key written to the memory of the security module. An example of the secure initialization process is depicted in FIG. 4.

In some examples, the machine-readable instructions further generate a pairing value based on the processor module identifier and a security module identifier that identifies the security module. The machine-readable instructions send the pairing value from the security module to the processor module to store in a memory of the processor module. The secure initialization process is further based on using the authentication key as a secret to access the pairing value from the processor module.

In some examples, as part of the secure initialization process, the secure initialization instructions 716 can retrieve the processor module identifier and the random number from the processor module, generate an authentication key based on the processor module identifier and the random number retrieved as part of the secure initialization process, and compare the generated authentication key to the authentication key from the memory of the security module.

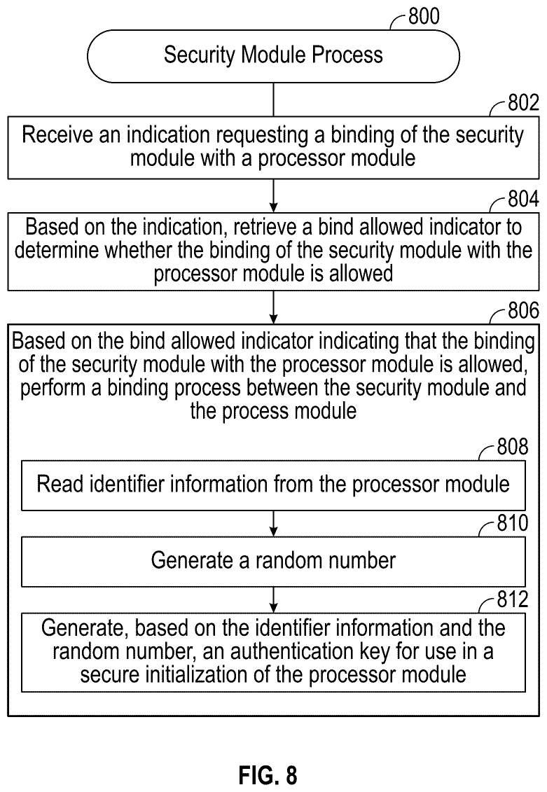

FIG. 8 is a flow diagram of a process 800 performed by a security module. The process 800 can be a secure re-binding process such as shown in FIG. 5.

A controller of the security module receives (at 802) an indication requesting a binding of the security module with a processor module. This indication may be a re-binding indication (e.g., as received at 512 in FIG. 5). A re-binding is performed to allow the security module to be a replacement security module that replaces a previous security module bound to the processor module.

Based on the indication, the controller of the security module retrieves (at 804) a bind allowed indicator to determine whether the binding of the security module with the processor module is allowed. In some examples, the bind allowed indicator includes the Rebind Allowed flag 166 (FIG. 1) stored at the processor module.

Based on the bind allowed indicator indicating that the binding of the security module with the processor module is allowed, the controller of the security module performs (at 806) a binding process between the security module and the processor module, where the binding process includes reading (at 808) identifier information (e.g., a serial number) from the processor module, generating (at 810) a random number, and generating (at 812), based on the identifier information and the random number, an authentication key for use in a secure initialization of the processor module.

In some examples, based on the bind allowed indicator indicating that the binding of the security module with the processor module is not allowed, the controller of the security module performs a process to change a value of the bind allowed indicator.

In some examples, the process to change the value of the bind allowed indicator includes determining, by the controller, whether the security module contains an existing authentication key, and based on the secure module not containing the existing authentication key, changing the value of the bind allowed indicator to indicate that the binding of the security module with the processor module is allowed. the binding process is performed after the changing of the value of the bind allowed indicator to indicate that the binding of the security module with the processor module is allowed.

A “BMC” (e.g., the BMC 108 of FIG. 1) can refer to a specialized service controller that monitors the physical state of a computing system using sensors and communicates with a remote management system (that is remote from the electronic device) through an independent “out-of-band” connection. The BMC can perform management tasks to manage components of the computing system. Examples of management tasks that can be performed by the BMC can include any or some combination of the following: power control to perform power management of the computing system (such as to transition the computing system between different power consumption states in response to detected events), thermal monitoring and control of the computing system (such as to monitor temperatures of the computing system and to control thermal management states of the computing system), fan control of fans in the computing system, system health monitoring based on monitoring measurement data from various sensors of the computing system, remote access of the computing system (to access the computing system over a network, for example), remote reboot of the computing system (to trigger the computing system to reboot using a remote command), system setup and deployment of the computing system, system security to implement security procedures in the computing system, and so forth.

In some examples, the BMC can provide so-called “lights-out” functionality for a computing system. The lights out functionality may allow a user, such as a systems administrator, to perform management operations on the computing system even if an OS is not installed or not functional on the computing system.

Moreover, in some examples, the BMC can run on auxiliary power provided by an auxiliary power supply (e.g., a battery); as a result, the computing system does not have to be powered on to allow the BMC to perform the BMC's operations. The auxiliary power supply is separate from a main power supply that supplies powers to other components (e.g., a main processor, a memory, an input/output (I/O) device, etc.) of the computing system.

A storage medium (e.g., 800 in FIG. 8) can include any or some combination of the following: a semiconductor memory device such as a DRAM or SRAM, an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A first security module comprising:
a connector interface to removably connect to a processor module; and
a controller to:
retrieve information stored at the processor module, the information set by a second security module when binding the second security module with the processor module;
read a first authentication key from a memory of the first security module;
compute a second authentication key based on the information retrieved from the processor module; and
determine whether to allow an initialization of the processor module based on the first authentication key and the second authentication key.

2. The first security module of claim 1, wherein the first security module is different from or the same as the second security module.

3. The first security module of claim 1, wherein the controller is to prevent the initialization of the processor module based on the controller determining that the second authentication key is different from the first authentication key.

4. The first security module of claim 3, wherein a mismatch of the second authentication key and the first authentication key indicates that the first security module is different from the second security module.

5. The first security module of claim 1, wherein the first authentication key was generated by the first security module when binding with a processor module.

6. The first security module of claim 1, wherein the information retrieved from the processor module comprises a random number generated by the second security module,
wherein the second authentication key is based on the random number.

7. The first security module of claim 6, wherein the controller is to:
retrieve a serial number from the processor module,
wherein the second authentication key is based on the random number and the serial number.

8. The first security module of claim 7, wherein the serial number is set while the processor module is in a factory mode.

9. The first security module of claim 8, wherein the serial number is set by the second security module.

10. The first security module of claim 9, wherein after the setting of the serial number the processor module is transitioned to a production mode,
wherein the information is retrieved by the first security module from the processor module in the production mode.

11. The first security module of claim 1, wherein the controller is to:
request, from the processor module, a pairing value generated by the second security module based on first information of the processor module and second information of the second security module, wherein the request comprises a controller-provided authentication key sent from the controller to the processor module, the controller-provided authentication key comprising the first authentication key or the second authentication key; and
receive, at the controller, the pairing value from the processor module in response to the request, wherein the receipt of the pairing value indicates a validity of the controller-provided authentication key.

12. The first security module of claim 11, wherein the first information comprises a serial number of the processor module, and the second information comprises a serial number of the second security module.

13. The first security module of claim 11, wherein the pairing value comprises a hash value derived from applying a hash function on the first information and the second information.

14. A non-transitory machine-readable storage medium comprising instructions that upon execution cause a security module to:
as part of a binding process to bind the security module to a processor module:
retrieve, from the processor module, a processor module identifier that identifies the processor module;
generate a random number;
send the random number from the security module to the processor module;
generate an authentication key based on the processor module identifier and the random number;
send the authentication key from the security module to the processor module; and
write the authentication key to a memory of the security module; and
perform a secure initialization process with the processor module that uses the authentication key written to the memory of the security module.

15. The non-transitory machine-readable storage medium of claim 14, wherein the instructions that upon execution cause the security module to:
generate a pairing value based on the processor module identifier and a security module identifier that identifies the security module; and
send the pairing value from the security module to the processor module to store in a memory of the processor module,
wherein the secure initialization process is further based on using the authentication key as a secret to access the pairing value from the processor module.

16. The non-transitory machine-readable storage medium of claim 14, wherein the instructions that upon execution cause the security module to:
as part of the secure initialization process,
retrieve the processor module identifier and the random number from the processor module,
generate an authentication key based on the processor module identifier and the random number retrieved as part of the secure initialization process, and
compare the generated authentication key to the authentication key from the memory of the security module.

17. The non-transitory machine-readable storage medium of claim 14, wherein the authentication key comprises a hash value derived by applying a hash function on the processor module identifier and the random number.

18. A method of a security module, comprising:
receiving, by a controller of the security module, an indication requesting a binding of the security module with a processor module;
based on the indication, retrieving, by the controller, a bind allowed indicator to determine whether the binding of the security module with the processor module is allowed; and
based on the bind allowed indicator indicating that the binding of the security module with the processor module is allowed, performing, by the controller, a binding process between the security module and the processor module, the binding process comprising:
reading identifier information from the processor module,
generating, by the controller, a random number,
generating, based on the identifier information and the random number, an authentication key for use in a secure initialization of the processor module.

19. The method of claim 18, comprising:
based on the bind allowed indicator indicating that the binding of the security module with the processor module is not allowed, performing, by the controller, a process to change a value of the bind allowed indicator.

20. The method of claim 19, wherein the process to change the value of the bind allowed indicator comprises:
determining, by the controller, whether the security module contains an existing authentication key; and
based on the secure module not containing the existing authentication key, changing the value of the bind allowed indicator to indicate that the binding of the security module with the processor module is allowed,
wherein the binding process is performed after the changing of the value of the bind allowed indicator to indicate that the binding of the security module with the processor module is allowed.
